(19) United States
(12) Patent Application Publication
(10) Pub. No.: US 2020/0055776 A1
(43) Pub. Date: Feb. 20, 2020

(54) Concrete Element Reinforced with Improved Oxidation Protection

(71) Applicant: Solidian GmbH, Albstadt (DE)

(72) Inventors: Marcus Hinzen, Albstadt (DE); Georgios Toskas, Altenriet (DE); Andreas Tulke, Albstadt (DE)

(21) Appl. No.: 16/609,351

(22) PCT Filed: May 3, 2018
(86) PCT No.: PCT/EP2018/061370

§ 371 Date: Oct. 29, 2019

(30) Foreign Application Priority Data
May 3, 2017 (DE) 10 2017 109 476.8

(51) Int. Cl. C04B 20/10; C04B 20/12; C04B 28/00; C04B 28/02; C04B 14/38; C04B 16/06

(52) U.S. Cl. CPC C04B 20/1051; C04B 20/12; C04B 28/006; C04B 2111/28; C04B 14/386; C04B 16/0633; C04B 28/02

(57) ABSTRACT

A concrete element with improved fire resistance having a textile reinforcement, such as carbon fibers. The concrete covers the textile reinforcement around 10 to 25 mm, the concrete being made from binding agents based on geopolymers or calcium-aluminate cements or Portland cement or blast furnace cement combined with an increased concentration of more than 2 kg/m³ polypropylene fibres and high temperature resistant aggregates. The textile reinforcement with fibers/filaments are impregnated with an impregnation mass/resin, ensuring, even at very high temperatures, a transmission of force between the fibres and the impregnation mass and protecting against the entry of oxygen. It also contains an organic faction of, for example, a maximum of 20 wt. %, wherein the impregnation masses being used, have a filler which is stable at high temperatures in an added amount of, for example, at least 12.5% in the form of particles.

The invention relates to approaches for improving the oxidation protection of high performance fibers, in particular carbon fibers, which are used as reinforcement in concrete and which must have the required fire resistance in the component. In particular, the invention relates to a thin concrete element having a special concrete composition in combination with a reinforcement made of carbon fibers having a special high temperature-resistant impregnation means, which gives the concrete element very good behavior in the case of fire.

### INTRODUCTION

Carbon fibers can be embedded in concrete in the form of a weave, a laid scrim, an individual bar, or individual bars welded into mats. By nature, they consist essentially of carbon, whose structure allows the fibers to have special mechanical properties, in particular high strength and a high modulus of elasticity. The fibers are usually impregnated with an impregnation mass to activate all filaments as uniformly as possible, that is to make all filaments participate in load bearing as uniformly as possible. This can bring the tensile strength of such a composite reinforcement clearly closer to the tensile strength of the filament. The impregnation masses that have been used up to now are thermoset resin systems, preferably epoxy resins, or aqueous dispersions, preferably styrene-butadienes. The hardened textile reinforcements are arranged in the concrete analogously to how steel reinforcements are arranged, and bond to the concrete through a form-fit or contribute in part to providing an adhesive bond. Textile reinforcements are not susceptible to chloride-induced corrosion, and therefore do not, in contrast to reinforcing steel, require any concrete cover. This allows concrete structures to be especially slender and have long working lives.

The fire resistance of a component is of decisive importance for the evaluation of fire protection. Fire resistance is measured as the duration for which a component maintains its function in case of fire. A requirement that is commonly placed on structures endangered by fire is the fire resistance class “F90 fire resistant” (it is functional for at least 90 minutes in case of fire). In conventional steel-reinforced concrete construction, protection for 90 minutes is achieved above all through a sufficiently large concrete cover.

### Statement of Problem

Since textile-reinforced concrete is defined on the basis of the fact that it is thin-walled, with concrete covers of less than 20 mm, and textile reinforcements have only limited resistance to high temperatures, up to now components with textile reinforcement have not had the corresponding load-bearing functionality in the case of fire. While the carbon reinforcement can easily manage the usual operating temperatures up to 80° C., so far no solutions have been available for the case of fire with temperatures up to 1,000° C. To accomplish this, new material approaches must be found.

The inadequate high temperature behavior is attributable to two factors. The causes of this have to do, on the one hand, with the purely organic impregnation masses that are currently used. As is known, these soften above their glass-transition temperature, which for most polymers lies below 100° C., and they completely evaporate in the temperature range up to 400° C. Therefore, in the case of fire the described strengthening effect of the impregnation mass is lost within a few minutes.

Independent of that, at increased temperatures above about 400° C. the carbon structure undergoes chemical changes. Oxidation processes and the combustion of carbon play a special role. Without an oxidative attack, carbon fibers are stable up to temperatures far over 1,000 degrees. If it is desired to use carbon fibers at high temperatures, it is necessary to protect the carbon skeleton in an appropriate way from oxidation and combustion.

Resulting Requirements Profile on the Reinforcement

The problem that has been described makes the requirements profile for a fire-resistant textile reinforcement extremely complex; it can be summarized as follows:
The high performance fiber must be protected from oxidation for at least 60 minutes, ideally 90 minutes, and thus the entry of oxygen must be prevented or delayed in time
In case of fire, the impregnation mass that is used must maintain a sufficient residual stiffness and residual strength to ensure the inner bond (filament/filament) and outer bond (fiber/concrete)
Material solutions must be convertible into economical processes
The concrete cover of a component must be fire-resistant, and in case of fire it may not crack off, since this concrete cover should contribute in part to providing a heat buffer, however above all it should act as a first oxygen barrier
The fire-resistant composite reinforcement must achieve a sufficient tensile strength of at least 3,000 MPa at a normal temperature
All substances used must be permanently alkali-resistant up to pH 13.5, to be able to withstand the alkaline environment of concrete

### STATE OF RESEARCH/PRIOR ART

The literature has frequently reported possible ways of protecting carbon fibers from oxidation. For high temperature applications such as, for example fiber-reinforced ceramics, various mechanisms are proposed and also used for treating carbon fibers. This involves striving for long-lasting protection for temperatures above 1,000° C. The first step is usually to put substances into the rovings by vapor-deposition or other gas phase processes. It is also possible to put substances on the surface of the fibers by infiltration of liquid components. Here it is important to cover the filament surfaces as completely as possible. E.g., Si-organic compounds are used.

The substances cannot yet achieve any protective effect in their original form, so after they are applied to the fiber surface they must be converted into a dense and stable layer by a conversion process. This can be achieved, e.g., by vitrification. As a rule, this involves heating under shielding gas conditions or in a vacuum to temperatures over 1,200° C., at which the input materials are converted into a glass-like, dense layer.

An example of a polymer-based ceramic is the commercially available resin Polyramic®, which is hardened in a rapid radical cross-linking mechanism at 125-150° C. Then, the resin undergoes further treatment at up to 1,400° C. in a pyrolysis process.

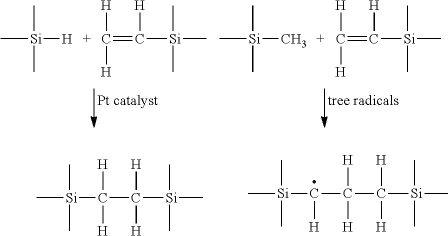

Moreover, the use of fiber-reinforced ceramics (CMC=Ceramic Matrix Composites) would also be conceivable as a composite reinforcement. Corresponding materials have sufficient temperature stability to withstand fire for over 90 minutes. However, such materials have relatively low tensile strengths. The low tensile strengths of classic CMCs, together with their high production costs, make it pointless to use them for reinforcing concrete. For the same reason, the use of ceramic fibers, which as such also have sufficient temperature stability, in combination with resin systems that can be more economically processed is also not sensible.

However, the processes for applying protective layers onto fibers could possibly be borrowed from the preparation processes of fiber-reinforced ceramics (CMC=Ceramic Matrix Composites). The mental approach here would be to treat the protective layer as a “ceramic matrix”. Important processes for preparing ceramic composite materials, some of which can be carried out with very different process parameters, are the following:

| | |
|---|---|
| LPI (Liquid Polymer Infiltration) | polymer pyrolysis (also called PIP) |
| CVI (Chemical Vapor Infiltration) | chemical gas phase infiltration |
| LSI (Liquid Silicon Infiltration) | liquid silicon process |
| Sol-gel process/wet process | |

TABLE
Comparison of typical parameters of different CMCs

| Material type | CVI-C/SiC | LPI-C/SiC | LSI-C/SiC | Al₂O₃/Al₂O₃ | Al₂O₃ | SSiC |
|---|---|---|---|---|---|---|
| Density | 2.1-2.2 | 1.8 | 1.9-2.0 | 2.1 | 3.9 | 3.2 |
| [g/cm³] | | | | | | |
| Tensile | 300-320 | 250 | 80-190 | 65 | 250 | ~200 |
| strength [MPa] | | | | | | |
| Strain [%] | 0.6-0.9 | 0.5 | 0.15-0.35 | 0.12 | 0.1 | 0.05 |
| Modulus of | 90-100 | 65 | 50-70 | 50 | 400 | 395 |
| elasticity | | | | | | |
| [GPa] | | | | | | |
| Bending | 450-500 | 500 | 160-300 | 80 | 450 | 400 |
| strength [MPa] | | | | | | |
| Fiber | 42-47 | 46 | 55-65 | | — | — |
| proportion [%] | | | | | | |
| Porosity [%] | 10-15 | 10 | 2-5 | 35 | <1 | <1 |
| ILS [MPa] | 45-48 | 10 | 28-33 | 3-10 | — | — |

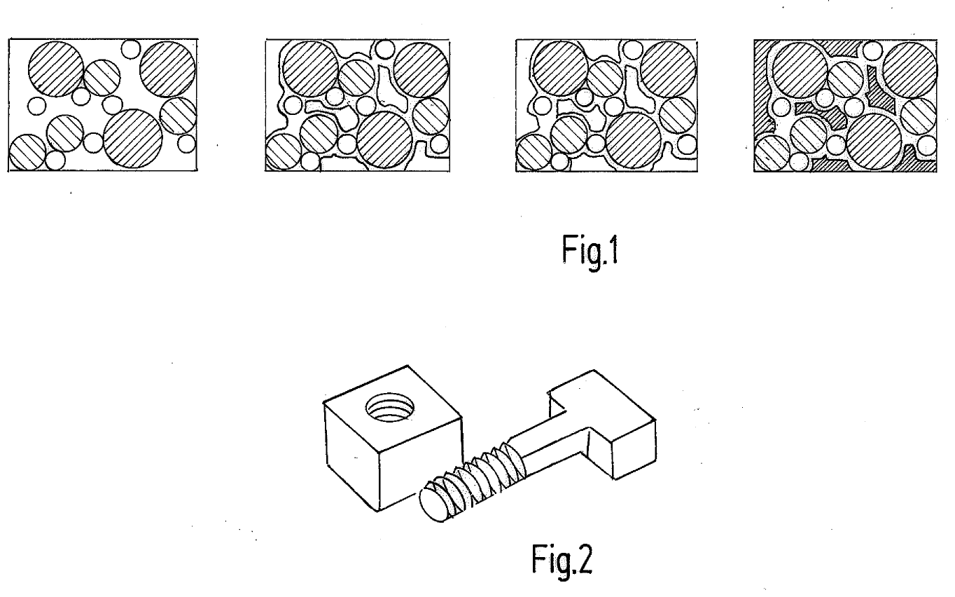

FIGS. 1 through 3 mentioned below briefly describe above-mentioned processes, which should be considered prior art.

FIG. 1: The LPI process

FIG. 2: The CVI process

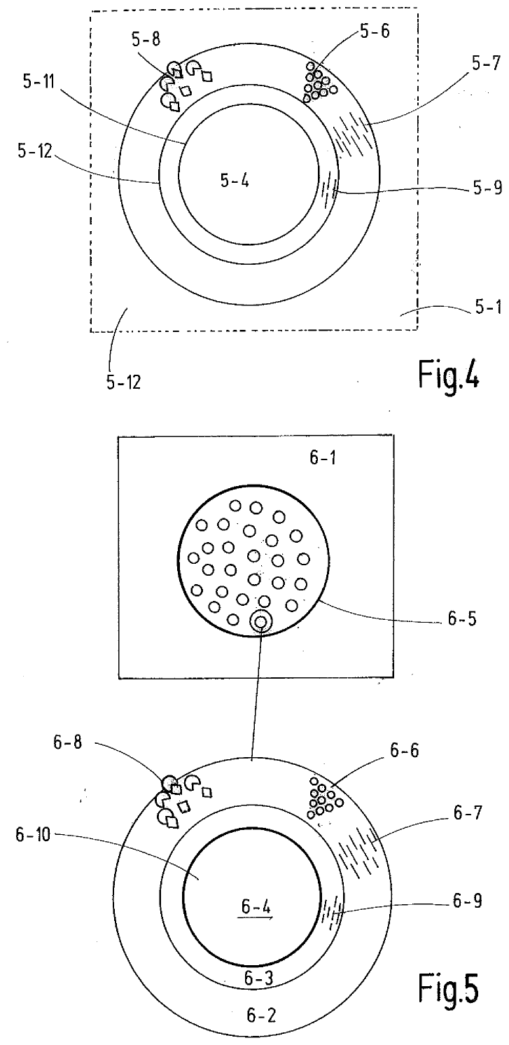

FIG. 4: The sol-gel process

The processes LPI, CVI, and LSI are used for processing carbon fibers, among other things. By contrast, the sol-gel process is usually used to produce CMCs from ceramic fibers.

FIG. 1:

The LPI process is very frequently used to produce CMCs with a SiC matrix; depending on the precursor (preceramic polymer), it is also possible to produce matrixes composed of N, O, B, Al, and Ti.

Prepreg (C or SiC fibers+Si polymer+ceramic filler)→put in mold and fix with vacuum bag→harden in autoclave→reaction shrinkage produces porous matrix→mold removal and green treatment→pyrolysis at 800-1,300° C. ↔(5-10 times) infiltration with precursor

Advantages:
Good control over matrix composition
No more elemental silicon in matrix
Ability to produce near-net-shape components

Disadvantages:
Relative long production time due to many infiltration and pyrolysis cycles
Residual porosity diminishes mechanical properties
Relatively high production costs

FIG. 2:

The picture shows a CMC screw and nut produced using the CVI process (Techtrans.de)

Produce fiber preform→pass process gas through reaction chamber with preform→compress matrix: matrix is deposited onto preform until pores are closed→open pores⇒porous SIC matrix→return to step 2 or→finished CMC component

Advantages:
Little pre-damage to fibers because of low process temperatures
High purity of matrix
Good mechanical properties (strength, strain, toughness)
Good thermal shock resistance
Increased resistance to creeping and oxidation due to fine crystalline structure
Fiber coating can be produced with the same process
Matrix depends only on process gas (SC, C, Si₃N₄, BN, B₄C, ZrC, etc.) (e.g., CH₃CL₃Si? SIC+3HCl)

Disadvantages:
Process is slow (takes up to several weeks)
High porosity (10-15%)
High production costs
No production of thick-walled components

Concerning the LSI Process:

The LSI process is the only process that has been used for a longer time in the series production of, e.g., brake rotors.

C-fiber and precursor (resin)→carbon-fiber-reinforced polymer RTM Autoklac, wind→pyrolysis to porous C/C (800-1,200° C.) under shielding gas→intermediate processing (soft processing)→siliconizing Si+C⇒SiC Tmax=1,650° C. vacuum→C/C—SIC

Advantages:
Low costs and short production times
Very low residual porosity (<3%)
High thermal conductivity
Good oxidation resistance

Disadvantages:
Mediocre mechanical properties due to reaction of some C fibers with SiC
High process temperature could damage fibers
Not all Si is converted to SiC.

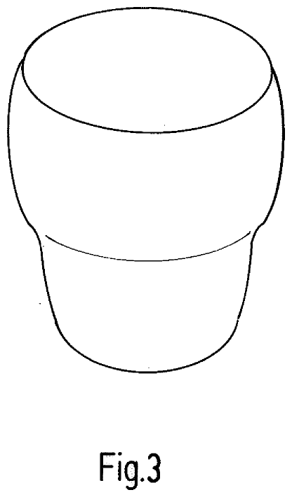

FIG. 3:

Preparing Oxide CMCs Using the Sol-Gel Process

Fiber preform is soaked in sol (colloidal suspension of fine ceramic particles)→insert in mold/put in mold/wind (WHIPDX®)/laminate→heat preform: (sol turns into gel) subsequent drying at 400° C.→repeat infiltration and drying processes until desired density is reached→fire to ceramic matrix

Advantages:
Adjustable matrix composition
Low costs for apparatus (hand lamination)
Low finishing costs due to near-net-shape production
Large and complex parts are possible

Disadvantages:
Matrix cracks are possible due to high oscillation
Poor mechanical properties
High costs of the sols

Legend for FIG. 4:
5-1 concrete
5-2 resin
5-3 sizing agent
5-4 fiber
5-6 filler to reduce shrinkage
5-7 layered silicate in the form of an oxygen barrier in the resin
5-8 Antioxidants “oxygen scavengers”
5-9 layered silicates in the form of an oxygen barrier in the sizing agent
5-10 oxygen barrier directly on sizing agent
5-11 oxygen barrier directly on fiber
5-12 cracking off avoided by concrete technology measures

Legend for FIG. 5:
6-1 concrete
6-2 resin
6-3 sizing agent
6-4 fiber
6-5 outer protective covering
6-6 filler to reduce shrinkage
6-7 graphene/Laponite® serves as oxygen barrier in resin
6-8 antioxidants serve as oxygen scavengers
6-9 oxidation inhibiting phosphorus additives (e)
6-10 reduced electrochemical activation (d)

Even in today's processes for preparing CMCs, additional protective layers are applied to the reinforcing fibers, whether they be carbon or ceramic fibers. In addition to the function of serving as a protective layer, especially to reduce or delay oxidative degradation, the bond to the ceramic matrix should have a positive influence. Such solutions are described in the book by Walter Krenkel entitled “Ceramic Matrix Composites”, GB book number 6418. According to this book, the coatings can in the form of a single layer or multiple layers:
Glass sealing (mullite, aluminum, MoSi₂ (MAN)
CVD coatings (β-SIV (111), BoraSiC, sandwich of SiC/B₄C/SiC)
Main protective layer (pure carbon matrix, salt impregnation, SI (P75, P76, P77), CVI mullite layers, other additives)
Nanoscale multilayers (PyC, SiC, BN, B₄C)

On the whole, the processes described up to now require elaborate apparatus, run slowly, and require a great deal of time and high temperatures. Thus, in the form in which they are currently known and used, they are unsuitable for treating carbon fibers for construction applications.

As a rule, impregnation masses for concrete reinforcements are of an organic nature, in order that they have the elongation at break that is required for composite materials. For standard systems, carbon fiber manufacturers have developed correspondingly matched sizing agents. Incombustible impregnation masses or impregnation masses with the highest possible residual masses at 1,000° C. are by nature inorganic. Thus, they have the associated low elongation at break and brittle material behavior. This means that during the stress of the component, inorganic impregnation masses or binders can form cracks or microcracks, which promote the entry of oxygen. Therefore, reinforcements with purely inorganic impregnation masses exhibit inadequate load bearing performance, also not least of all because of the poor fiber/matrix adhesion.

In addition is the currently existing problem that most silicon-based materials are not highly alkali-resistant. All the above-described processes are aimed at aerospace or automobile applications, and therefore their development did not pay any attention to alkali resistance. However, the natural concrete environment is highly alkaline (up to pH 13.5), and leads to a more or less strongly pronounced decomposition of many silicon-based systems.

### DESCRIPTION OF THE INVENTION

Based on the described problem and the requirements, this invention provides a three-stage solution concept:
1. Protecting the composite reinforcement by a concrete cover, in particular by an especially stable concrete cover
2. Using a fire-resistant, alkali-resistant, and dimensionally stable impregnation mass to maintain the inner bond in case of fire, in particular a fire-resistant and dimensionally stable impregnation resin.
3. Adding sizing agents and/or impregnation masses and/or coatings to create a barrier effect against oxygen transport, in particular arranging barrier functions provided by additives either directly on the fiber level, in the impregnation resin, or on the impregnation resin.

In contrast to the comparable problems in conventional fiber-reinforced plastics in automobile construction or aerospace, achieving the fire protection requirements in the construction industry requires protection of the carbon fibers for only a limited time and up to a limited temperature. For example, the time duration can be limited to 90 minutes, and the temperature can be limited to range below 1,000° C. This opens new possibilities for materials that have been disregarded up to now. However, the protection mechanisms must satisfy other constraints. A comparatively simple and economical application process must be used. Conventional vacuum processes and high temperature steps for producing the protective effect are not possible.

1. Protecting the Composite Reinforcement by the Concrete Cover

The concrete cover, which is usually 10 mm to 20 mm thick, can perform the first protective function in case of fire. However, for certain applications, concrete covers of up to 25 mm or even up to 30 mm can also be used. They can prevent direct action of flame on the carbon reinforcement and reduce the temperature to which the reinforcement is subjected by about 100° C. in the mentioned range of thickness. In the same way, they can form the first barrier layer for inflowing oxygen.

To achieve the mentioned functions, the concrete cover may not crack off the component under the action of fire. While in the case of conventional steel reinforced concrete, which also only achieves the required fire resistance class if the concrete cover is intact, 2 kg of polypropylene fibers are added per m³ of concrete to prevent cracking off, preliminary tests have found that in the case of textile-reinforced concretes this is inadequate, due to the denser pore structure. However, it has been shown that the following concrete technology measures can prevent cracking off, even in the case of textile-reinforced concrete, especially when high-strength and very dense mortars for textile-reinforced concrete are used in certain combinations:
The use of high temperature-resistant binders based on geopolymers, alkaline-activated concrete admixtures, and/or calcium aluminous cements.
Alternatively or in addition: The use of a clearly higher dosage of polypropylene fibers of at least 3 kg/m³, preferably 4 kg/m³.
Alternatively or in addition: The use of basalt aggregate gravels instead of quartzitic and calcitic aggregate gravels.
Alternatively or in addition: Use of material with small maximum particle sizes of 8 mm, preferably 4 mm.
Alternatively: Use of conventional binders based on Portland cement in combination with
   a higher dosage of polypropylene fibers of at least 2 kg/m³, preferably 3-4 kg/m³.
   Alternatively or in addition: The use of basalt aggregate gravels instead of quartzitic and calcitic aggregate gravels.
   Alternatively or in addition: Use of material with small maximum particle sizes of 8 mm, preferably 4 mm.

2. Using a Fire-Resistant Impregnation Mass to Maintain the Inner Bond in Case of Fire

To maintain the inner bond in case of fire for a longer time, it is possible to use impregnation masses that allow power transmission between the filaments up to very high temperatures. It has been shown that the inner bond can be maintained better, even at high temperatures, using impregnation masses whose organic component is as small as possible an, e.g., a maximum of 20%. In contrast to purely inorganic substances such as silicate or cement binders, it is possible, with substances from the group of silicon-organic compounds, to achieve final characteristics similar to those of epoxy resin with the same high ceramic yield in case of fire.

Organopolysiloxanes, especially silicone resins such as, in particular the substance group of the methyl resins and the methylphenyl resins, such as, e.g., methyl phenyl vinyl and hydrogen-substituted siloxanes, and mixtures of the silicone resins and organic resins in question, have proved to be suitable. Although in the case of silicon-organic compounds no alkali-resistance at all should be expected, it was surprisingly possible to prove this for certain formulations (e.g., Wacker SILRES® H62 C and in combination with SILRES® MK) for the special application concrete reinforcement. In the case of methyl phenyl vinyl hydrogen polysiloxanes (e.g., Wacker SILRES® H62 C), methyl polysiloxanes (e.g., Wacker SILRES® MK), and especially suitable mixtures of the two siloxanes, it was possible to prove already surprisingly high alkali-resistance in the field of application of concrete reinforcement.

However, inorganic impregnation masses with an organic component, in particular predominantly inorganic impregnation masses, even those that also have an organic component, still tend, despite clearly better high-temperature resistance, to form a porous structure or microcracks in the high-temperature range between 500° C. and 1,000° C. However, even predominantly inorganic impregnation masses, even those that also have an organic component, still tend, despite clearly better high-temperature resistance, to form a porous structure or microcracks in the high-temperature range between 500° C. and 1,000° C. Therefore, it can be advantageous to add to these resins a high proportion of high-temperature stable fillers, e.g., in the form of particles, to reduce the formation of shrinkage-inducing microcracks at high temperature. However, a certain part of the shrinkage is required for mechanical adhesion of the resin to the fibers for power transmission at high temperature. The fillers usually simultaneously occupy spaces that are then no longer available for the transport of oxygen, achieving an oxidation protection.

To make the impregnation process economical, it can be advantageous to use fillers on the nanoscale range when producing reinforcing meshes. This avoids sifting of the particles by the fiber strands and, consequently achieves a comparatively uniform distribution of the fillers. To avoid agglomerations and to comply with occupational safety, it is possible to predisperse the fillers in solvents or resin components. For example, solvents, which are required anyway to form films of solid resins, can be enriched in advance with high contents of fillers. To accomplish this, liquid resins can be enriched with fillers directly, or additional solid resins can be dissolved in the correspondingly modified liquid resins. This makes it possible to avoid the use of solvents entirely, or at least almost entirely.

Substance combinations that have proved to be especially advantageous are the solid methyl resin Wacker SILRES® MK in combination with the filler-containing solvent toluene and/or in combination with the filler-containing liquid oligomeric methyl resins Wacker Trasil and Wacker IC 368. Depending on the final viscosity, which is limited by the process, it is advantageously possible to select the proportion of solid resins with maximum ceramic yield and/or the filler content to be as large as possible. It is conceivable, e.g., for the solvent to have a solids concentration of 75% of a solid resin and simultaneously have a filler content of 50%. This corresponds to a filler content of 12.5% in the ready-to-use processing resin. That is, preferably a filler content of at least 12.5% is used. In special cases, it is also possible for smaller filler contents of at least 5% or at least 10% to be sufficient. To increase the filler concentration, it is possible to use dispersants such as, e.g., POSS® (Polyhedral Oligomeric Silsesquioxane).

Further examples that have proved especially advantageous with regard to behavior in fire are the solid methyl resin Wacker SILRES® MK in combination with SiO₂ nanoparticles in solvent or Al₂O₃ particles and the oligomeric methyl resin Wacker Trasil. An especially advantageous example of a resin with sufficient alkali resistance is the phenylmethyl resin Wacker SILRES® H 44. Combining different resin systems can also lead to a combination of properties.

Depending on the final viscosity, which is limited by the process, it is also advantageously possible to select the proportion of solid resins in the solvent and/or the filler content to be as large as possible. For example, it is conceivable for filler contents to be up to 50% in a silicon-organic resin. To increase the filler concentration, it is possible to use dispersants such as, e.g., POSS® (Polyhedral Oligomeric Silsesquioxane).

Advantageous fillers are listed below:
AL₂O₃
Boron nitride
Kaolins
Wollastonite
Cristobalite
Titanium dioxide
Silicon dioxide
Mullite
Zirconia

It is also advantageously possible to produce preceramic networks, which usually form below 1,000° C. Here the combination of epoxy and phenyl siloxanes is considered especially advantageous, since, as expected, the epoxy component provides better bonds and the phenyl component provides better heat resistance.

3. Arranging Barrier Functions by Additives, Either Directly on the Fiber Level, in the Impregnation Resin, or on the Impregnation Resin, or Oxidation Protection Functions on the Carbon Fiber, in Particular Adding Sizing Agents and/or Impregnation Masses and/or Coatings to Create a Barrier Effect Against Oxygen Transport:

An essential element for increasing the fire resistance of textile-reinforced concrete is preventing oxidation of the carbon fibers in the composite component. The entry of oxygen or oxygen-containing compounds (to the carbon fibers) can, by suitable barriers, be completely avoided at least for a certain time, or at least it can be reduced for a sustained period. As is explained below, such barriers can be produced at different places.
A barrier can be produced directly on the surface of the carbon fibers, even before a sizing agent is applied to the carbon fibers, which is typically done to ensure workability.
Alternatively or in addition, an oxidation barrier can also provided by a correspondingly modified sizing agent, which is applied to the still unsized carbon fibers.
Alternatively or in addition, an oxidation barrier can be produced by postprocessing of a carbon fiber roving that has already been provided with a sizing agent.
Alternatively or in addition, oxidation protection can be achieved by modifying the resin system used for impregnation of the roving. Here the protection would then be provided through the resin that is applied to a coated roving. The idea here is analogous to that in point 2, in particular, instead providing the oxidation protection by adding a solvent to a liquid resin, which is then mixed with a solid resin and is applied to the roving, or adding the oxidation protection additive directly into a liquid resin and applying it to the roving.
Furthermore, it is alternatively or additionally possible also to apply an oxidation protection system from the outside, onto the roving, which is already coated with a resin. This outer protective covering with barrier effect can consist of a high temperature-resistant, low-shrinkage and low-oxidation, e.g., preferably aluminum phosphate salts and/or aluminum phosphate silicates and/or aluminum oxide and/or silicon
An oxidation barrier can be provided by a correspondingly modified sizing agent, which is applied to the still unsized carbon fibers. The modification can comprise phosphorus additives or additives with similar effect.

A combination of the above-mentioned variants is considered especially effective.

The oxidation barriers in question can be achieved through the following material concepts, among others:
Graphene oxide, graphenes, graphites, or modifications of them. Ideally, the mentioned substances are in the form of a planar, nanoscale substance, which can be used as a pure substance or as an additive to a sizing agent, a resin, or a postprocessing layer. The parallel orientation of the planar nanolayers reduces the transport of water or oxygen (literature data: water or oxygen transport is reduced by >90% when graphene oxide is present in polymer films at a concentration of 0.5 weight percent), which has the final result of delaying oxidation of the carbon fibers protected in this way.
Alternatively or in addition, by Laponite®. Laponites are nanoscale synthetic layered silicates. They are produced by the company BYK Chemie, among others, and up to now their essential use has been as rheological modifiers. These also can form a temperature-stable oxidation barrier if they are suitably interleaved as a pure layer or an additive.
Alternatively or in addition, by nanosilica. Nanosilica is offered by the company Evonik, among others, and is used as a nanoscale, spherical filler for the tire industry, among other things. They can also form a temperature-stable oxidation barrier when used as a pure layer or as an additive. The literature (Evonik) reports water or gas transport reduced by up to 60% at a particle content of 50%.

Here again, it is advantageously possible to use the above-mentioned material implementation possibilities in combination.

Another possibility is for the carbon fibers to be less strongly electrochemically activated in the production process, e.g., before the application of sizing agent, making an attack of oxygen more difficult.

Alternatively or in addition to the above-described construction of barriers, it is also possible to use so-called oxygen scavengers/antioxidants.

Antioxidants are used in the plastics and man-made fiber industry as additives to delay thermo-oxidative degradation processes. They are usually additives that when added to the plastic, for example, act as radical scavengers, and bind chemical radicals that form by chemically reacting with them. Such antioxidants can be used as an additive, e.g., in the impregnation resin or in the sizing agent. The antioxidants bind oxygen that was already able to get into the layer with the antioxidants (e.g., by overcoming protection barriers before it), binding it and thus keeping it away from the carbon fibers. When combined with the previously described solutions, the use of antioxidants can protect the carbon fibers from oxidation even longer. The antioxidants are preferably elements that can, after sufficient temperature input, be oxidized and thus bind oxygen and keep it away from the carbon fibers. When combined with the previously described solutions, the use of antioxidants can protect the carbon fibers from oxidation even longer.

1. Combination

It is to be expected that sufficient fire-resistance (e.g., fire resistance class F90), in particular one that is achieved by protecting the carbon fibers from oxygen, can be achieved only by combining more than one, or all of the mechanisms discussed in points 1 through 3.

Since a high fire resistance class is characterized by strongly time-dependent mechanisms, it is to be expected that sufficient fire-resistance, in particular one that is achieved by protecting the carbon fibers from oxygen, can be achieved only by combining more than one, or all of the mechanisms discussed in points 1 through 3.

FIGS. 4 and 5 show all previously described mechanisms in combination.

1. A concrete element that has improved fire resistance with a textile reinforcement including carbon fibers, the concrete element comprising at least one or more of:
a) a concrete cover, which covers the textile reinforcement and which has a thickness of 10 to 20 mm, the concrete cover any one or combination of containing high temperature-resistant binders based on geopolymers, containing polypropylene fibers in a concentration of at least 4 kg/m³, produced with aggregate gravel only having particle sizes of up to 8 mm,
b) carbon fibers or filaments of the textile reinforcement that are impregnated with an impregnation mass, the impregnation mass containing, at most an organic component of 20%, the impregnation mass containing silicon-organic compounds and/or high temperature-stable fillers,
c) carbon fibers of the textile reinforcement that are surrounded by oxidation barriers that protect the carbon fibers from oxidation, the oxidation barriers being realized by one or more of
direct application to the surface of the carbon fibers before the application of a sizing agent to the carbon fibers,
application of at least one modified sizing agent prior to application of a sizing agent to the carbon fibers,
postprocessing of a carbon fiber roving of the textile reinforcement that has already been provided with a sizing agent,
modifying a resin system used for impregnation of the carbon fiber roving,
applying an oxidation protection system from outside onto the carbon fiber roving, which has already been coated with a resin,
d) antioxidants, which are contained in the oxidation barriers.

2. A concrete element that has improved fire resistance, with a textile reinforcement including carbon fibers, the concrete element comprising:
a) a concrete cover, which covers the textile reinforcement and which has a thickness of 10 to 20 mm, the concrete cover comprising at least one or any combination of high temperature-resistant binders based on geopolymers,
alkaline-activated concrete admixtures;
calcium aluminous cements; and
a binder in combination with a concentration of more than 3 kg/m³ polypropylene fibers and high temperature-resistant basalt aggregate gravels with particle sizes of up to a maximum of 8 mm, and
b) the carbon fibers or filaments of the textile reinforcement are impregnated with an impregnation mass, the impregnation mass containing, silicon-organic compounds, and/or high temperature-stable fillers in the form of particles.

3. The concrete element according to claim 1 wherein the carbon fibers of the textile reinforcement have an oxidation protection function on a surface of the carbon fibers which protects the carbon fibers from oxidation from the action of oxygen, the oxidation protection function being realized by at least one of:
reduced electrochemical activation of the carbon fibers during the production process, which reduces the oxidation capabilities of the carbon fibers; and
use of at least one modified sizing agent, which is applied prior to application of a sizing agent to the carbon fibers.

4. The concrete element according to claim 1, wherein the textile reinforcement contains additives in a resin of the textile reinforcement that have a barrier effect and that have a flake-shaped geometry.

5. The concrete element according to claim 1, wherein the textile reinforcement has an outer protective covering with a barrier effect, the outer protective covering including a high temperature-resistant, low-shrinkage and low-diffusion system, including at least one of aluminum phosphate salts, aluminum phosphate silicates, aluminum oxide, and silicon.

6. The concrete element according to claim 1, wherein the textile reinforcement contains antioxidative elements in a resin of the textile reinforcement that allow oxidation above a certain temperature to protect the carbon fibers from free oxygen.

7. A concrete element that has improved fire resistance, with a textile reinforcement including carbon fibers, the concrete element comprising:
a) a concrete cover which covers the textile reinforcement and which has a thickness of 10 to 25 mm, the concrete cover comprising at least one of high temperature-resistant binders based on geopolymers;
alkaline-activated concrete admixtures;
calcium aluminous cements; and
Portland cement or blast furnace slag cement in combination with a concentration of more than 2 kg/m³ polypropylene fibers and high temperature-resistant aggregate gravels with particle sizes of up to a maximum of 8 mm, and
b) the textile reinforcement, wherein the carbon fibers or filaments thereof are impregnated with an impregnation mass, the impregnation mass containing an organic component that is at most 20%, the impregnation mass containing silicon-organic compounds, and/or high temperature-stable fillers in the form of particles.

8. The concrete element according to claim 7, wherein the carbon fibers of the textile reinforcement have, on a surface thereof, an oxidation protection function that protects the carbon fibers from oxidation from the action of oxygen, the oxidation protection function being realized
by reduced electrochemical activation of the carbon fibers during the production process, which reduces the oxidation capabilities of the carbon fibers; and/or
by the use of at least one modified sizing agent, which is applied prior to application of a sizing agent to the carbon fibers.

9. The concrete element according to claim 7, wherein the textile reinforcement contains additives in a resin of the textile reinforcement that have a barrier effect and have a flake-shaped geometry.

10. The concrete element according to claim 7, wherein the textile reinforcement contains antioxidative elements in a resin of the textile reinforcement that allow oxidation above a certain temperature to protect the carbon fibers from free oxygen.

11. The concrete element according to claim 7, wherein the textile reinforcement has an outer protective covering with a barrier effect made of a high temperature-resistant, low-shrinkage and low-diffusion system, including at least one of aluminum phosphate salts, aluminum phosphate silicates, aluminum oxide, and silicon.

12. The concrete element according to claim 1, wherein a proportion of the fillers is at least 12.5 percent by weight.

13. The concrete element according to claim 2, wherein the carbon fibers of the textile reinforcement have an oxidation protection function on a surface of the carbon fibers which protects the carbon fibers from oxidation from the action of oxygen, the oxidation protection function being realized by use of at least one of:
reduced electrochemical activation of the carbon fibers during the production process, which reduces the oxidation capabilities of the carbon fibers; and
at least one modified sizing agent, which is applied prior to application of a sizing agent to the carbon fibers.

14. The concrete element according to claim 2, wherein the textile reinforcement contains additives in a resin of the textile reinforcement that have a barrier effect and that have a flake-shaped geometry.

15. The concrete element according to claim 2, wherein the textile reinforcement has an outer protective covering with a barrier effect, the outer protective covering including a high temperature-resistant, low-shrinkage and low-diffusion system, including at least one of aluminum phosphate salts, aluminum phosphate silicates, aluminum oxide, and silicon.

16. The concrete element according to claim 2, wherein the textile reinforcement contains antioxidative elements in a resin of the textile reinforcement that allow oxidation above a certain temperature to protect the carbon fibers from free oxygen.
